(19) United States
(12) Patent Application Publication
(10) Pub. No.: US 2023/0116543 A1
(43) Pub. Date: Apr. 13, 2023

(54) ROTARY MACHINE

(71) Applicant: MEIDENSHA CORPORATION, Tokyo (JP)

(72) Inventors: Taku UEMATSU, Tokyo (JP); Hiromasa MASHIKO, Tokyo (JP)

(73) Assignee: MEIDENSHA CORPORATION, Tokyo (JP)

(21) Appl. No.: 17/912,365

(22) PCT Filed: Mar. 9, 2021
(86) PCT No.: PCT/JP2021/009177

§ 371 Date: Sep. 16, 2022

(30) Foreign Application Priority Data
Mar. 19, 2020 (JP) 2020-048836

(51) Int. Cl. H02K 5/20; H02K 9/19

(52) U.S. Cl. CPC H02K 5/203; H02K 9/19

(57) ABSTRACT

The present invention relates to a rotary machine. An object of the present invention is to provide a rotary machine with improved cooling performance. A motor (10) includes: a frame (13) that covers a stator (11) from an outer side in a radial direction, and a first bracket (14) that covers one side in an axial direction of the frame (13), in which either or both the frame (13) and the first bracket (14) include a second flow passage (18a, 18b) connected with a first opening (17a) and located on the outer side in the radial direction of the first coil end (11c) on a mating surface between the frame (13) and the first bracket (14), and the second flow passage (18a, 18b) includes a third flow passage (18a) disposed over a circumferential direction, and a fourth flow passage (18b) disposed at a plurality of places in the circumferential direction including at least a lower side in a vertical direction of the first coil end (11c), being connected with the third flow passage (18a), and penetrating toward the first coil end (11c).

### TECHNICAL FIELD

The present invention relates to rotary machines.

### BACKGROUND ART

Rotary machines generate heat by being driven, and degradation in efficiency or the like may occur. Hence, cooling is desired. For example, in order to cool a coil end of a stator, cooling oil is made to flow to the coil end.

In Patent Literature 1, a frame that accommodates a stator and brackets joined to both end surfaces in an axial direction of the frame are provided, and grooves through which the cooling oil is made to flow are formed on at least one of mating surfaces of the frame and the brackets. The grooves open toward the coil end either above or beside the coil end, and the cooling oil that has flowed from openings flows to the coil end.

### CITATION LIST

### Patent Literature

Patent Literature 1: JP 4441338 B2

### SUMMARY OF INVENTION

### Technical Problem

In Patent Literature 1, it is configured that the cooling oil is made to flow to the coil end from either above or beside the coil end, and the oil that has passed through an upper-side coil end flows down to a lower-side coil end. For this reason, the temperature of the oil that has reached the lower-side coil end is increased, and sufficient cooling is not enabled, and there is room for improvement in cooling performance.

An object of the present invention is to provide a rotary machine with improved cooling performance.

### Solution to Problem

A rotary machine according to one aspect of the present invention includes: a stator including a stator core and a coil wound around the stator core; a rotor disposed to face the stator via an air gap; a frame that covers the stator from an outer side in a radial direction; and a first bracket that covers one side in an axial direction of the frame, in which the coil includes a first coil end that protrudes on the one side in the axial direction of the stator core, the frame includes a first flow passage that penetrates from an inlet on the outer side in the radial direction to a first opening on the one side in the axial direction, either or both the frame and the first bracket include a second flow passage on a mating surface between the frame and the first bracket, the second flow passage being connected with the first opening and located on the outer side in the radial direction of the first coil end, and the second flow passage includes a third flow passage and a fourth flow passage, the third flow passage being disposed over a circumferential direction, the fourth flow passage being disposed at a plurality of places in the circumferential direction including at least a lower side in a vertical direction of the first coil end, being connected with the third flow passage, and penetrating toward the first coil end.

The rotary machine according the above one aspect may further include a second bracket that covers the other side in the axial direction of the frame, in which the coil may include a second coil end that protrudes on the other side in the axial direction of the stator core, the first flow passage penetrates from the first opening to a second opening on the other side in the axial direction, either or both the frame and the second bracket may include a fifth flow passage on a mating surface between the frame and the second bracket, the fifth flow passage being connected with the first opening and located on the outer side in the radial direction of the second coil end, and the fifth flow passage may include a sixth flow passage and a seventh flow passage, the sixth flow passage being disposed over the circumferential direction, the seventh flow passage being disposed at a plurality of places in the circumferential direction including at least a lower side in the vertical direction of the second coil end, being connected with the sixth flow passage, and penetrating toward the second coil end.

In the rotary machine according the above one aspect, the second flow passage may be formed by a first groove recessed on the other side in the axial direction provided on a surface of the frame facing the first bracket, and a surface of the first bracket facing the first groove, and the fifth flow passage may be formed by a second groove recessed on one side in the axial direction provided on a surface of the frame facing the second bracket, and a surface of the second bracket facing the second groove.

In the rotary machine according the above one aspect, the first opening may be located on an upper side in the vertical direction of the first coil end, and the second opening may be located on an upper side in the vertical direction of the second coil end.

### Advantageous Effects of Invention

According to one aspect of the present invention, a rotary machine with improved cooling performance can be provided.

### BRIEF DESCRIPTION OF DRAWINGS

FIG. 1 is a perspective view of a rotary machine according to a first embodiment of the present invention.

FIG. 2 is a side cross-sectional view illustrating a motor 10 of FIG. 1 cut along a plane orthogonal to Z axis and passing through a central axis J.

FIG. 3 is a perspective view illustrating the motor 10 of FIG. 1 from which a bracket 15 is removed.

FIG. 4 is a perspective view illustrating the motor 10 of FIG. 1 from which a bracket 14 is removed.

### DESCRIPTION OF EMBODIMENTS

Hereinafter, embodiments of the present invention will be described with reference to the drawings. In the embodiments, in order to facilitate understanding, structures and elements other than the main parts of the present invention will be described in a simplified or omitted manner. In addition, in the drawings, the same elements are denoted by the same reference numerals. Note that the shapes, dimensions, and the like of the respective elements illustrated in the drawings are schematically illustrated, and do not indicate actual shapes, dimensions, or the like.

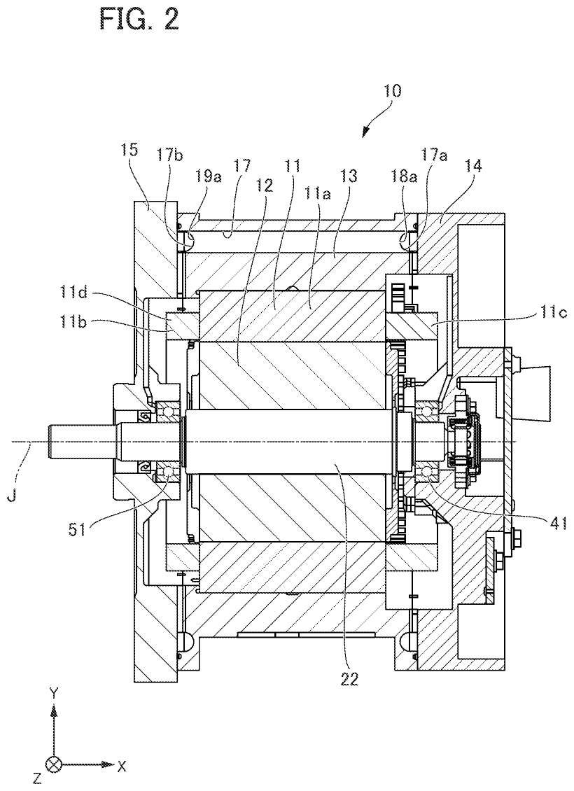

Note that in the following description, a direction in which the central axis J illustrated in FIG. 2 extends will be simply referred to as an “axial direction”, a radial direction centered on the central axis J will be simply referred to as a “radial direction”, and a circumferential direction centered on the central axis J will be simply referred to as a “circumferential direction”. In addition, in the axial direction, the right side in FIG. 2 will be referred to as one side, and the left side in FIG. 2 will be referred to as the other side. Further, in the radial direction, a side close to the central axis J will be referred to as an inner side, and a side far from the central axis J will be referred to as an outer side.

Further, in the drawings, an XYZ coordinate system will be illustrated as a three-dimensional orthogonal coordinate system, as needed. In the XYZ coordinate system, an X-axis direction is a direction parallel to the central axis J, and is a left-right direction of the side cross-sectional view illustrated in FIG. 2. A Y-axis direction is a direction orthogonal to the X-axis direction, and is an up-down direction in the side cross-sectional view illustrated in FIG. 2. A Z-axis direction is a direction orthogonal to the X-axis direction and the Y-axis direction. In any of the X-axis direction, the Y-axis direction, and the Z-axis direction, + side denotes a side on which an arrow illustrated in the drawing points, and − side denotes an opposite side.

In addition, in the following description, extending or spreading in the axial direction includes not only a case of strictly extending or spreading in the axial direction (X-axis direction) but also a case of extending or spreading in a direction inclined within a range smaller than 45° with respect to the axial direction. In addition, in the following description, extending or spreading in the radial direction includes not only a case of strictly extending or spreading in the radial direction, that is, the axial direction (X-axis direction) but also a case of extending or spreading in a direction inclined within a range smaller than 45° with respect to the radial direction.

<First Embodiment>

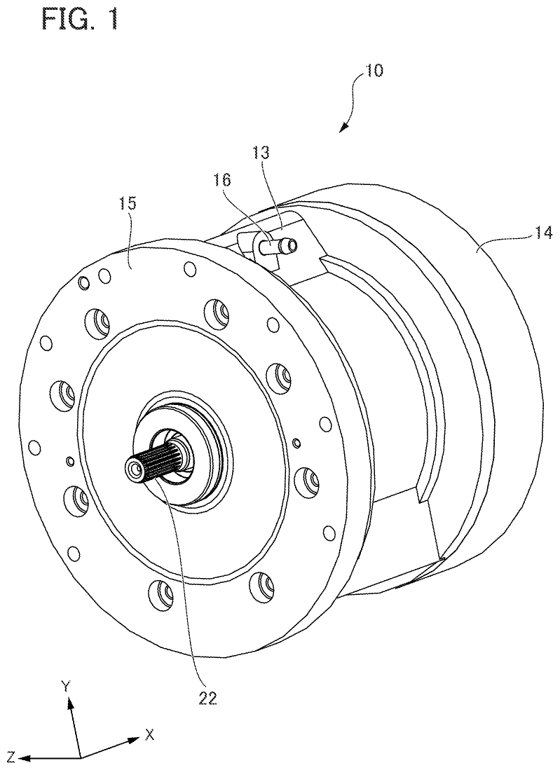

FIG. 1 is a perspective view of a motor according to a first embodiment of the present invention. FIG. 2 is a side cross-sectional view illustrating a motor 10 of FIG. 1 cut along a plane orthogonal to Z axis and passing through a central axis J. In the present embodiment, a motor as an example of a rotary machine will be described. The motor 10 is an example of the rotary machine.

The motor 10 includes a stator 11, a rotor 12, a frame 13, a bracket 14, and a bracket 15. The stator 11 includes a stator core 11a, and a coil 11b wound around the stator core 11a. The coil 11b includes a coil end 11c, which protrudes on one side in the axial direction of the stator core 11a, and a coil end 11d, which protrudes on the other side in the axial direction of the stator core 11a. The rotor 12 is disposed to face the stator 11 via an air gap. The rotor 12 is disposed on the inner side in the radial direction of the stator 11. The rotor 12 includes a shaft 22 disposed along the central axis J. The rotor 12 rotates about the shaft 22 as a rotation axis.

The frame 13 covers the stator 11 from an outer side in the radial direction. The frame 13 is, for example, aluminum die-cast. The bracket 14 covers one side in the axial direction of the frame 13. The bracket 14 covers an opening on one side in the axial direction of the frame 13 so as to close the opening. The bracket 15 covers the other side in the axial direction of the frame 13. The bracket 15 covers an opening on the other side in the axial direction of the frame 13 so as to close the opening. The shaft 22 penetrates the bracket 15.

The motor 10 includes a bearing 41, which pivotally supports the shaft 22 on one side in the axial direction, and a bearing 51, which pivotally supports the shaft 22 on the other side in the axial direction. The bracket 14 fixes the bearing 41. The bracket 15 fixes the bearing 51. The bearing 41 and the bearing 51 pivotally support the shaft 22 such that the rotor 12 is rotatable about the central axis J as a rotation axis.

The frame 13 includes an inlet 16 on the outer side in the radial direction. The inlet 16 is an inlet for the cooling oil. The cooling oil is an example of a cooling medium. Other known cooling media may be used instead of the cooling oil. The motor 10 causes the cooling oil to flow into the frame 13 from the inlet 16 by, for example, a pump. The frame 13 includes a flow passage 17, which penetrates from the inlet 16 to the opening 17a on one side in the axial direction. The opening 17a is an opening connected with the flow passage 17. The frame 13 includes the flow passage 17, which penetrates from the inlet 16 to an opening 17b on the other side in the axial direction. The opening 17b is an opening connected with the flow passage 17. The flow passage 17 penetrates from the opening 17a to the opening 17b. The cooling oil that has flowed from the inlet 16 flows toward both the opening 17a and the opening 17b.

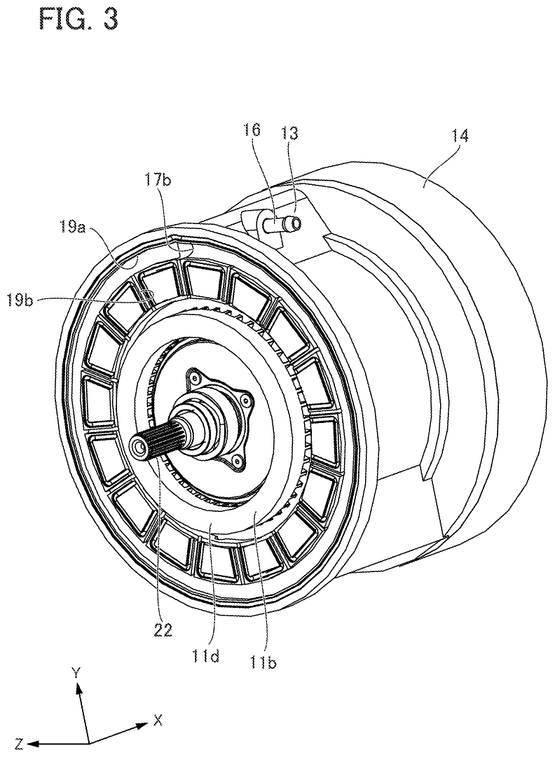

FIG. 3 is a perspective view illustrating the motor 10 of FIG. 1, from which the bracket 15 is removed. By removing the bracket 15 from the motor 10, the coil end 11d on the other side in the axial direction of the stator 11 can be seen. Note that in FIG. 3, the coil end 11d is simplified for ease of viewing.

The frame 13 includes flow passages 19a and 19b on mating surfaces of the frame 13 and the bracket 15. The flow passage 19a is connected with the opening 17b. The opening 17b is located on an upper side in a vertical direction of the coil end 11d. The flow passages 19a and 19b are located on an outer side in the radial direction of the coil end 11d. The flow passage 19a is disposed over the entire circumference in a circumferential direction. The flow passages 19b are respectively disposed at a plurality of places in the circumferential direction including at least a lower side in the vertical direction of the coil end 11d, are connected with the flow passage 19a, and penetrate toward the coil end 11d.

The flow passages 19a and 19b formed by grooves recessed on one side in the axial direction provided on the surface of the frame 13 facing the bracket 15, and the surface of the bracket 15 facing such grooves. The flow passages 19a and 19b may be formed by grooves recessed on one side in the axial direction provided on the surface of the frame 13 facing the bracket 15, and grooves recessed on the other side in the axial direction provided on the surface of the bracket 15 facing such grooves. The flow passages 19a and 19b may be formed by grooves recessed on the other side in the axial direction provided on the surface of the bracket 15 facing the frame 13, and the surface of the frame 13 facing such grooves.

In the present embodiment, 16 flow passages 19b are disposed at equal intervals in the circumferential direction. The cooling oil that has flowed from the inlet 16 is jetted from each of the plurality of flow passages 19b through the flow passage 17 and the flow passage 19a toward the coil end 11d.

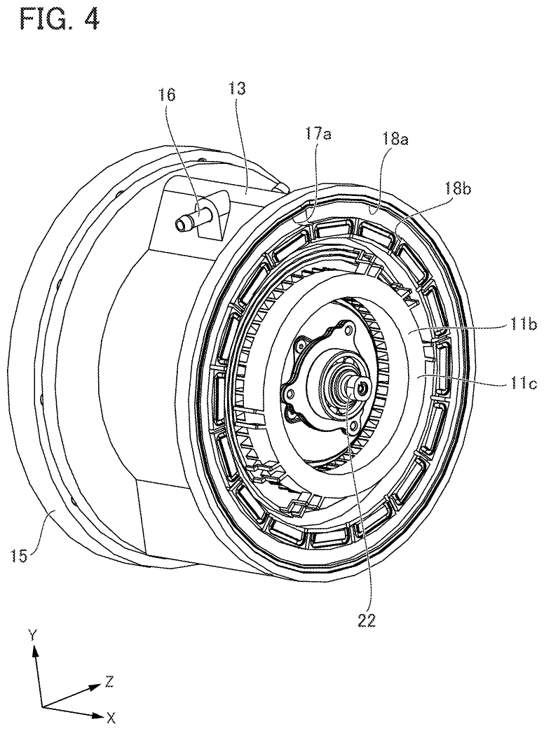

FIG. 4 is a perspective view illustrating the motor 10 of FIG. 1, from which the bracket 14 is removed. By removing the bracket 14 from the motor 10, the coil end 11c on the other side in the axial direction of the stator 11 can be seen. Note that in FIG. 3, the coil end 11c is simplified for ease of viewing.

The frame 13 includes flow passages 18a and 18b on mating surfaces of the frame 13 and the bracket 14. The flow passage 18a is connected with the opening 17a. The opening 17a is located on an upper side in the vertical direction of the coil end 11c. The flow passages 18a and 18b are located on an outer side in the radial direction of the coil end 11c. The flow passage 18a is disposed over the entire circumference in the circumferential direction. The flow passages 18b are respectively disposed at a plurality of places in the circumferential direction including at least a lower side in the vertical direction of the coil end 11c, are connected with the flow passage 18a, and penetrate toward the coil end 11c.

The flow passages 18a and 18b formed by grooves recessed on the other side in the axial direction provided on the surface of the frame 13 facing the bracket 14, and the surface of the bracket 14 facing such grooves. The flow passages 18a and 18b may be formed by grooves recessed on the other side in the axial direction provided on the surface of the frame 13 facing the bracket 14, and grooves recessed on one side in the axial direction provided on the surface of the bracket 14 facing such grooves. The flow passages 18a and 18b may be formed by grooves recessed on one side in the axial direction provided on the surface of the bracket 14 facing the frame 13, and the surface of the frame 13 facing such grooves.

In the present embodiment, 16 flow passages 18b are disposed at equal intervals in the circumferential direction. The cooling oil that has flowed from the inlet 16 is jetted from each of the plurality of flow passages 18b through the flow passage 17 and the flow passage 18a toward the coil end 11c.

According to the present embodiment, the oil passages (flow passages 18a, 18b, 19a, and 19b) are provided on the surfaces where the frame 13 faces the brackets 14 and 15. Therefore, this eliminates the need for providing a separate component part such as an oil guide for the oil passage, and does not increase the manufacturing process.

In addition, the oil jetted to the coil end on a lower side is not the oil having the temperature that has been increased, while flowing through the coil end on an upper side. Therefore, the coil end on a lower side can also be cooled in a sufficient manner, and the cooling performance can be improved.

Further, a first oil passage (flow passages 18a and 19a) is disposed on an outer side in the radial direction of the coil ends 11c and 11d, and the plurality of second oil passages (flow passages 18b and 19b) are disposed in the circumferential direction from the first oil passage toward the coil ends 11c and 11d. Therefore, the oil can be jetted from a plurality of places in the circumferential direction toward the coil ends 11c and 11d, and the coil ends 11c and 11d can be cooled in an efficient manner.

According to the present embodiment, the first oil passage (flow passages 18a and 19a) and the second oil passage (flow passage 18b and 19b) are formed by the grooves provided on the surfaces of the frame 13 respectively facing the brackets 14 and 15. Therefore, this enables the oil passages (flow passages 18a, 18b, 19a, and 19b) to be formed easily, eliminates the need for providing a separate component part such as an oil guide for the oil passage, and does not increase the manufacturing process.

According to the present embodiment, oil can be supplied to the oil passages (flow passages 18a, 18b, 19a, and 19b) from the outside of the frame 13, and the coil ends 11c and 11d can be cooled in an efficient manner.

According to the present embodiment, the connection point between the flow passage 17 and the flow passages 18a and 19a is located on an upper side in the vertical direction of the coil ends 11c and 11d. Thus, the oil that has flowed into the flow passages 18a and 19a from the flow passage 17 reaches a lower side in the vertical direction of the flow passages 18a and 19a by its own weight, and the lower side in the vertical direction of the coil ends 11c and 11d can be cooled in an efficient manner.

The present invention is not limited to the above embodiments, and various improvements and design changes may be made without departing from the gist of the present invention. In addition, the embodiments disclosed herein are to be considered in all respects as illustrative and non-limiting ones. The scope of the present invention is indicated not by the above description but by the scope of claims, and it is intended that meanings equivalent to the claims and all modifications within the scope are included.

The present application claims priority based on Japanese Patent Application No. 2020-048836 filed on Mar. 19, 2020, the entire contents of which are incorporated herein by reference.

### REFERENCE SIGNS LIST

10 Motor
11 Stator
13 Frame
22 Shaft

1. A rotary machine comprising:
a stator including a stator core and a coil wound around the stator core;
a rotor disposed to face the stator via an air gap;
a frame that covers the stator from an outer side in a radial direction; and
a first bracket that covers one side in an axial direction of the frame, wherein
the coil includes a first coil end that protrudes on the one side in the axial direction of the stator core,
the frame includes a first flow passage that penetrates from an inlet on the outer side in the radial direction to a first opening on the one side in the axial direction,
either or both the frame and the first bracket include a second flow passage on a mating surface between the frame and the first bracket, the second flow passage being connected with the first opening and located on the outer side in the radial direction of the first coil end, and
the second flow passage includes a third flow passage and a fourth flow passage, the third flow passage being disposed over a circumferential direction, the fourth flow passage being disposed at a plurality of places in the circumferential direction including at least a lower side in a vertical direction of the first coil end, being connected with the third flow passage, and penetrating toward the first coil end, and
the fourth flow passage is a flow passage for causing a cooling medium that has flowed from the inlet to jet toward the first coil end.

2. The rotary machine according to claim 1, further comprising a
second bracket that covers the other side in the axial direction of the frame, wherein
the coil includes a second coil end that protrudes on the other side in the axial direction of the stator core,
the first flow passage penetrates from the first opening to a second opening on the other side in the axial direction,
either or both the frame and the second bracket include a fifth flow passage on a mating surface between the frame and the second bracket, the fifth flow passage being connected with the first opening and located on the outer side in the radial direction of the second coil end, and
the fifth flow passage includes a sixth flow passage and a seventh flow passage, the sixth flow passage being disposed over the circumferential direction, the seventh flow passage being disposed at a plurality of places in the circumferential direction including at least a lower side in the vertical direction of the second coil end, being connected with the sixth flow passage, and penetrating toward the second coil end, and
the seventh flow passage is a flow passage for causing the cooling medium that has flowed from the inlet to jet toward the second coil end.

3. The rotary machine according to claim 2, wherein
the second flow passage is formed by a first groove recessed on the other side in the axial direction provided on a surface of the frame facing the first bracket, and a surface of the first bracket facing the first groove, and
the fifth flow passage is formed by a second groove recessed on the one side in the axial direction provided on a surface of the frame facing the second bracket, and a surface of the second bracket facing the second groove.

4. The rotary machine according to claim 2, wherein
the first opening is located on an upper side in the vertical direction of the first coil end, and
the second opening is located on an upper side in the vertical direction of the second coil end.

5. The rotary machine according to claim 3, wherein
the first opening is located on an upper side in the vertical direction of the first coil end, and
the second opening is located on an upper side in the vertical direction of the second coil end.
